(19) United States
(12) Patent Application Publication
(10) Pub. No.: US 2011/0036823 A1
(43) Pub. Date: Feb. 17, 2011

(54) SYSTEM AND METHOD FOR SNOW AND ICE REMOVAL

(75) Inventor: James R. NELSON, Annville, PA (US)

Correspondence Address: MCNEES WALLACE & NURICK LLC, 100 PINE STREET, P.O. BOX 1166, HARRISBURG, PA, 17108-1166, US

(73) Assignee: James R. NELSON, Annville, PA (US)

(21) Appl. No.: 12/540,468

(22) Filed: Aug. 13, 2009

(51) Int. Cl. B60L 1/02; B60P 1/64

(52) U.S. Cl. 219/202; 280/418.1

(57) ABSTRACT

A system and method for removing frozen precipitation that has accumulated on a surface of a road vehicle is disclosed. The system includes a heating array attached to the surface and a power source. When energized by the power source, the heating array generates heat that melts the frozen precipitation from the surface.

### FIELD OF THE INVENTION

The present invention is generally directed to the removal of ice and snow, and more particularly to a system and method for removing ice and snow from the surface of a truck trailer.

### BACKGROUND OF THE INVENTION

The accumulation of snow and/or ice, hereinafter referred to as “frozen precipitation” on the surface or roof of road vehicles such as vans, trucks, semi-trailer trucks and other large vehicles presents a substantial problem. Frozen precipitation may accumulate on the roof of the vehicle while the vehicle is stopped, parked or otherwise stationary, and may also accumulate on the vehicle roof while the vehicle is moving.

If the frozen precipitation is not removed from the roof of the vehicle, slabs or other solid mass forms of the frozen precipitation may become separated from the vehicle roof and fly off or otherwise fall from the moving vehicle. The flying mass may strike or impact one or more vehicles following behind the moving vehicle, may cause another vehicle to swerve to avoid the flying mass, and/or may form an obstruction on the road surface. In such a manner, the flying and/or obstruction mass may cause damage or lead to an accident. For example, the flying mass may impact and break a windshield of a following car and result in one or more accidents. For at least these reasons, some jurisdictions require that ice and/or snow be removed from a vehicle before the vehicle may travel on roadways.

In some attempts to remove frozen precipitation from the roof of a vehicle, an operator may climb on the roof and remove the frozen precipitation by shoveling, scraping or other similar manual method. For example, see U.S. Patent Pub. No. 2008/0086919, which discloses a scraping device for removing snow from a vehicle. However, such methods represent a substantial safety and cost issue for the operator.

In other attempts, frozen precipitation may be removed from a vehicle roof surface by a static structure that includes a horizontal member that removes the frozen precipitation by scraping the vehicle roof as that the vehicle passes beneath the structure. In yet other attempts, an operator may move the vehicle to or into a facility where the frozen precipitation is removed by heating and/or spraying with de-icing and/or melting agents. However, these attempts are only practical wherein a large number of vehicles are present so as to justify the expense thereof. They do not provide a solution for a single or few vehicles that can be in a location wherein such a structure is not available.

Thus, a long felt need exits to economically remove frozen precipitation from a surface of a road vehicle.

What is needed is a system and method to remove frozen precipitation from the roof of a road vehicle, and in particular to remove frozen precipitation from a large vehicle such as a tractor-trailer.

### SUMMARY OF THE INVENTION

A first aspect of the disclosure includes a snow and ice removal system for removing frozen precipitation from a surface of a vehicle. The system includes a heating array, a power source configured to provide electrical power to the heating array and generate heat, and a plurality of fasteners configured to attach the heating array to the surface of a vehicle.

A second aspect of the disclosure includes a semi-trailer including a surface, and a frozen precipitation removal system affixed to the surface. The frozen precipitation removal system includes a heating array configured to receive electrical power from a power source and generate heat.

A third aspect of the disclosure includes a method for removing frozen precipitation that has accumulated upon a surface of a road vehicle. The method includes providing a road vehicle having a surface and a heating array attached to the surface, electrically connecting the heating array to an electrical power source, and providing electricity from the electrical power source to the heating array to energize the heating array to generate heat and remove frozen precipitation from the surface of the road vehicle.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of a tractor-trailer having an exemplary embodiment of a snow and ice removal system according to the invention installed.

### DETAILED DESCRIPTION OF THE INVENTION

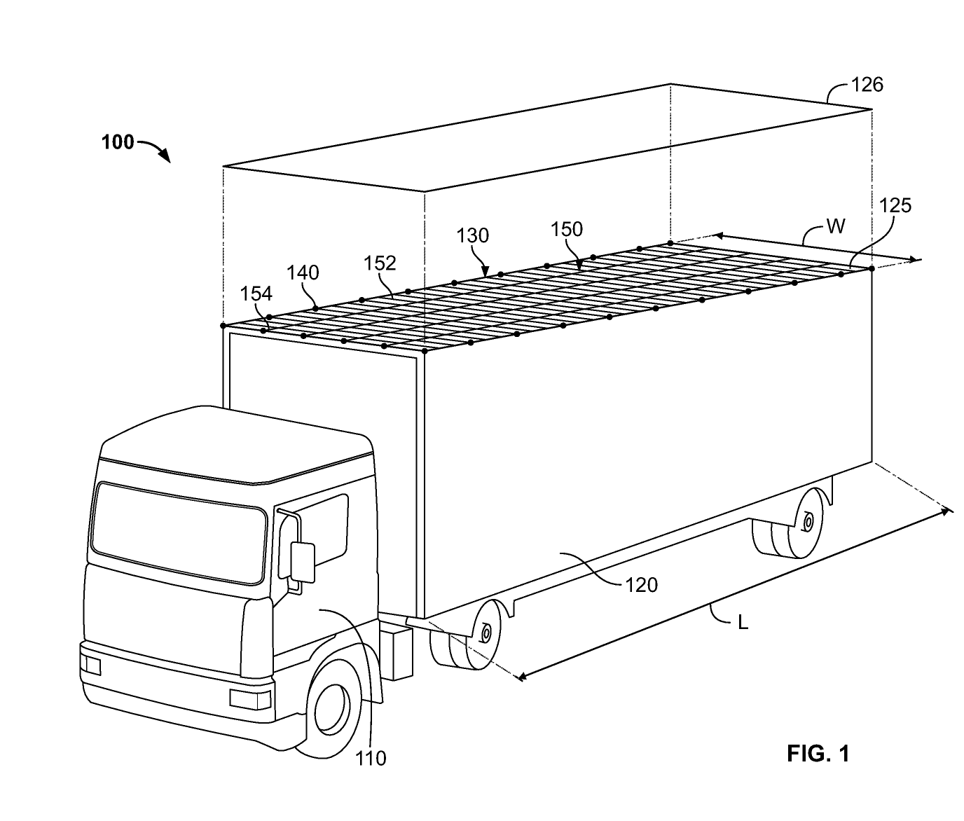

FIG. 1 illustrates a road vehicle 100 including a towing engine or trailer 110 and a semi-trailer 120 having an exemplary embodiment of a snow and ice removal system (system) 130 according to the disclosure attached thereto. Within this disclosure, the term “snow and ice” includes any form of frozen precipitation, including, but not limited to snow, ice, sleet, freezing rain and hail. Furthermore, in this exemplary embodiment, the road vehicle is a tractor trailer. However, in other embodiments, the road vehicle 100 may be any vehicle, motorized or non-motorized, that travel on a road, such as, but not limited to trucks, trailers, semi-trailers, towed oversized structures including housing structures and mobile homes.

The system 130 includes a heating array 150 and a power source (not shown). As can be seen in FIG. 1, the heating array 150 is attached to a surface 125 of the semi-trailer 120. In this exemplary embodiment, the surface 125 is the horizontal planar roof of the semi-trailer 120. In another embodiment, the surface 125 may be an upper surface of the semi-trailer 120. In another embodiment, the surface 125 may be non-planar. For example, the surface 125 may be stepped or otherwise discontinuous, or may be curved. In another embodiment, the surface 125 may include ridges or other non-planar elements.

The heating array 150 is attached to the surface 125 by fasteners 140. The fasteners 140 may be, but are not limited to, clips, loops, anchor hooks, hasps or other retainers. The fasteners 140 may detachably attach or permanently affix the system 130 to the surface 125. In one embodiment, the fasteners 140 are detachable from the surface 125. For example, the fasteners 140 may be detachably received in slots in the surface 125 or bolted to the surface 125. In another embodiment, the fasteners 140 are permanently affixed to the surface 125. For example, the fasteners 140 may molded into or welded to the surface 125. In one embodiment, the fasteners 140 allow the heating array 140 to be detached from the surface 125. The fasteners 140 retain the heating array 150 in substantial contact with the surface 125.

In this exemplary embodiment, the surface 125 is substantially planar or flat, however, in other embodiments, the surface 125 may be ridged or otherwise non-planar. In another embodiment, the heating array contacts the surface 125 at contact points. In yet another embodiment, the surface 125 may include channels, slots, grooves, toughs or other receiving features (not shown) for at least partially supporting and/or containing the heating array 150.

The heating array 150 includes a plurality of resistive heating elements 152 electrically connected in parallel across the width W of the semi-trailer 120. The resistive heating elements 152 may be electric cable having a hot insulated conductor and a neutral insulated conductor (not shown). The hot and neutral insulated conductors may be wrapped with a braided ground to protect against shock in the unlikely event that any of the plurality of resistive heating elements 152 are punctured.

The heating array 150 further includes an array of support lines 154 provided across the length L of the semi-trailer 120. The support lines 154 space the resistive heating elements 152 at a predetermined fixed spacing across the semi-trailer 120. In one embodiment, the support lines may be an elastic web. For example, the support lines may be formed of a heat-resistant polymer web material.

In another embodiment, the heating elements 152 may be provided across the length L of the semi-trailer 120, and the support lines 154 may be provided across the width W of the semi-trailer. In yet another embodiment, both heating elements 152 may be provided across both the length L and width W of the semi-trailer, and support lines 154 may be provided across the length L, width W, or combination thereof of the semi-trailer 120. In still another embodiment, the heating array 150 may be formed by a continuous resistive heating element (not shown). For example, the heating array 150 may be formed by a continuous resistive heating element sinusoidally arranged on the surface 125.

In another embodiment, the heating array 150 is constructed of a flexible, durable material, such as, but not limited to an elastic web formed of a vulcanized polymer, having heating elements 152 embedded therewithin. The heating array 150 is formed of flexible materials that permit the heating array 150 to be rolled or otherwise gathered for storage. The heating array 150 may include locking devices (not shown) to securely affix the heating array to the semi-trailer 120.

In one exemplary embodiment, the heating array 150 includes heating elements 152 formed of belts or strips of flexible heating elements in a square cross-hatching pattern over surface 125. In one embodiment, the heating elements 152 may be encased in a silicone or fiberglass shield.

In another embodiment, the heating array 150 is disposed between the surface 125 and an optional panel or cover layer 126. The cover 126 is shown in FIG. 1 removed and separated from the surface 125 for clarity. In this embodiment, the cover layer 126 overlays the surface 125 to substantially cover the surface 125. In other embodiments, the cover layer 126 may partially cover the surface 125. The cover layer 126 may be a metal, composite, fabric or plastic barrier that protects the heating array 150 from the environment or damage from outside forces such as rocks, tree limbs, debris and other structures.

In one embodiment, the heating array 150 is assembled to the surface 125 at the time of assembly of the semi-trailer 120. In yet another embodiment, the heating array 150 is retrofitted or otherwise later added to the semi-trailer 120 after the manufacture of the semi-trailer 120.

In one embodiment, the heating array 150 is electrically connected to a power source (not shown) via an electrical wire or cable (not shown). The electrical cable may be permanently attached or detachable from the heating array 150. In another embodiment, the electrical cable is attached to the power source and connected to the heating array 150. In one embodiment, the electrical cable is a No. 1 or No. 00 gauge copper wire cable. In one embodiment, an electrical power safety device (not shown) may be electrically disposed between the heating array 150 and the power source. For example, the electrical power safety device may be a fuse, breaker or other ground break device.

In one embodiment, the power source is a portable generator that is temporarily electrically connected to the heating array 150. The power source may or may not include the electrical cable used to attach the power source to the heating array. In one embodiment, the portable generator may be a 15 kw, 20 kw, 26 kw or 30 kw generator. In one embodiment, the power source provides between about 240 volt to about 480 volts. The portable generator may be gasoline or diesel fuel powered.

In another embodiment, the power source may be a solar power collector, such as a photovoltaic cell, that energizes the heating array 150. In another embodiment, the power source may be a battery. The battery may be carried by the road vehicle 100 or may be provided at a stationary location.

In one embodiment, the power source provides electrical energy to the heating array 150 to produce between about 1 to about 5 watt per square inch. In another embodiment the power source provides between about 2 to about 3 watt per square inch to the heating array 150. In another embodiment, the system 100 further includes a temperature control unit (not shown) to control the heat generated by the heating array 150. In one exemplary embodiment, the temperature control unit includes a resistance temperature sensor configured to regulate the heat of the heating array 150 to between about 150° F. to about 200° F. In another embodiment, the heating array 150 includes a inline temperature sensor probe to control the amount of heat generated by the heating array 150.

In another embodiment, the power source is an electrical supply point, such as an electrical outlet or an electrical source, such as a power panel, to which the electrical cable is attached. The power source provides electricity to the heating array 150 to substantially melt and thus remove any frozen precipitation that has accumulated on the surface 125 before the tractor trailer 100 begins to travel.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A snow and ice removal system for removing frozen precipitation from a surface of a vehicle, comprising
a heating array;
a power source configured to provide electrical power to the heating array and generate heat; and
a plurality of fasteners configured to attach the heating array to the surface of a vehicle.

2. The system of claim 1, wherein the heating array comprises a resistive heating element.

3. The system of claim 1, further comprising:
a cover layer that overlays the heating array.

4. The system of claim 1, wherein the power supply is a portable power generator.

5. The system of claim 1, wherein the power supply is an electrical power point source.

6. The system of claim 1, wherein the power source is electrically connected to the heating array by an electrical cable detachable from the heating array.

7. A semi-trailer comprising,
a surface; and
a frozen precipitation removal system affixed to the surface, the frozen precipitation removal system comprising a heating array configured to receive electrical power from a power source and generate heat.

8. The tractor trailer of claim 7, wherein the frozen precipitation removal system is removable from the surface.

9. The tractor trailer of claim 7, wherein the heating array comprises a resistive heating element.

10. The tractor trailer of claim 7, further comprising:
a cover layer that overlays the heating array and the surface.

11. The tractor trailer of claim 7, wherein the power supply is a portable power generator.

12. The tractor trailer of claim 7, wherein the power supply is an electrical power point source.

13. The tractor trailer of claim 7, wherein the power source is electrically connected to the heating array by an electrical cable detachable from the heating array.

14. A method for removing frozen precipitation from a surface of a road vehicle, comprising:
providing a road vehicle comprising a surface and a heating array overlaying the surface;
electrically connecting the heating array to an electrical power source; and
providing electricity from the electrical power source to the heating array to energize the heating array to generate heat to melt the frozen precipitation from the surface.

15. The method of claim 14, wherein the frozen precipitation removal system is removable from the surface.

16. The method of claim 14, wherein the heating array comprises a resistive heating element.

17. The method of claim 14, wherein the provided electricity energizes the heating array to generate between about 1 and about 5 watts per square inch.

18. The method of claim 14, wherein the power supply is a portable power generator.

19. The method of claim 14, wherein the power supply is an electrical power point source.

20. The method of claim 14, wherein the power source is electrically connected to the heating array by an electrical cable detachable from the heating array.
